(19) United States
(12) Patent Application Publication
(10) Pub. No.: US 2015/0278737 A1
(43) Pub. Date: Oct. 1, 2015

(54) Automatic Calendar Event Generation with Structured Data from Free-Form Speech

(71) Applicant: Google Inc., Mountain View, CA (US)

(72) Inventors: Chia-Nee Michelle Chen Huebscher, Mountain View, CA (US); Markus Cedric Huebscher, Mountain View, CA (US); Dino Wernli, Mountain View, CA (US)

(73) Assignee: Google Inc., Mountain View, CA (US)

(21) Appl. No.: 14/144,022

(22) Filed: Dec. 30, 2013

(51) Int. Cl. G06Q 10/06; G10L 21/00

(52) U.S. Cl. CPC G06Q 10/06314; G10L 21/00

(57) ABSTRACT

Embodiments described herein may involve methods and systems for automatic generation of a calendar event with structured data from free-form speech. An example method may involve receiving a speech segment, where the speech segment includes a spoken-language description of an event. In some cases, a determination can be made that portions of the spoken-language description correspond to time data, substance of the event, location of the event, and/or event attendees. This determination may then be used to generate a calendar-event object, where a when-field of the calendar-event object is set based on the time data, where a what-field of the calendar-event object is set based on the substance of the event, where a where-field of the calendar-event object is set based on the location of the event and determined location information, and/or where a who-field of the calendar-event object is set based on event-attendees.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to a wearer's (or user's) eye(s) such that the displayed image appears as a normal-sized image, such as might be displayed on a traditional image display device. The relevant technology may be referred to as “near-eye displays.”

Wearable computing devices with near-eye displays may also be referred to as “head-mountable displays” (HMDs), “head-mounted displays,” “head-mounted devices,” or “head-mountable devices.” A head-mountable display places a graphic display or displays close to one or both eyes of a wearer. To generate the images on a display, a computer processing system may be used. Such displays may occupy a wearer's entire field of view, or only occupy part of wearer's field of view. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible.

### SUMMARY

Example embodiments involve or otherwise relate to automatic generation of structured calendar events from free-form speech input. Methods and systems described herein may be implemented in a computing device such as a head-mountable device (HMD), or on other types of computing devices, such as a mobile phone. For example, an HMD may receive a speech segment from a user of the device, where the speech segment includes of a spoken-language description of the event. The HMD, or a cloud server in communication with the HMD, may then apply logic to parse out portions of the spoken-language description that correspond to specific types of data, such as what, when, where, and who fields, and may generate a structured calendar-event data object that includes such fields.

In one aspect, a method is provided. The method involves receiving a speech segment, where the speech segment is associated with a user-account, and where the speech segment includes a spoken-language description of an event. The method also involves determining, based on natural-language mapping data, that portions of the spoken-language description correspond to at least: (i) time data, (ii) event-substance data, and (iii) event-location data. The method additionally involves determining location information corresponding to the user-account. Further, the method also involves generating a calendar-event object comprising a when-field that is determined based at least in part on the time data, a what-field that is determined based at least in part on the event-substance data, and a where-field that is determined based at least in part on the event-location data and the determined location information.

In another aspect, a system is provided. The system includes a computing device. The computing device is configured to receive a speech segment, where the speech segment is associated with a user-account, and where the speech segment includes a spoken-language description of an event. The computing device is also configured to determine, based on natural-language mapping data, that portions of the spoken-language description correspond to at least: (i) time data, (ii) event-substance data, and (iii) event-location data. Additionally, the computing device is configured to determine location information corresponding to the user-account. Further, the computing device is configured to generate a calendar-event object comprising a when-field that is determined based at least in part on the time data, a what-field that is determined based at least in part on the event-substance data, and a where-field that is determined based at least in part on the event-location data and the determined location information.

In yet another aspect, a non-transitory computer readable medium is provided. The non-transitory computer readable medium has stored therein instructions executable by a computing device to cause the computing device to perform functions. The functions include receiving a speech segment, where the speech segment is associated with a user-account, and where the speech segment includes a spoken-language description of an event. The functions also include determining, based on natural-language mapping data, that portions of the spoken-language description correspond to at least: (i) time data, (ii) event-substance data, and (iii) event-location data. The functions additionally include determining location information corresponding to the user-account. Further, the functions also include generating a calendar-event object comprising a when-field that is determined based at least in part on the time data, a what-field that is determined based at least in part on the event-substance data, and a where-field that is determined based at least in part on the event-location data and the determined location information.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1A illustrates a wearable computing system according to an example embodiment.

FIG. 1B illustrates an alternate view of the wearable computing device illustrated in FIG. 1A.

FIG. 1C illustrates another wearable computing system according to an example embodiment.

FIG. 1D illustrates another wearable computing system according to an example embodiment.

FIGS. 1E to 1G are simplified illustrations of the wearable computing system shown in FIG. 1D, being worn by a wearer.

FIG. 2A is a simplified block diagram of a computing device according to an example embodiment.

FIG. 3 shows a flowchart illustrating an example method for generating a calendar event.

FIG. 4 shows example screen views for receiving a speech segment according to an example embodiment.

FIGS. 5A and 5B show example screen views of a generated calendar event according to an example embodiment.

FIG. 6 shows an example screen view for editing a generated calendar event according to an example embodiment.

FIG. 7 shows an example screen view of an event schedule.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. OVERVIEW

Example embodiments involve or otherwise relate to automatic generation of structured calendar events from a free-form speech input, which may be referred to as a “speech segment.” Various types of end-user devices, such as a head-mountable device (HMD) or mobile phone, may be used to provide a speech segment from which an example system may automatically generate a calendar event.

In an example embodiment, the speech segment may include a spoken-language description of the desired calendar event. Such a spoken-language description may be fairly crude, and thus may be referred to as “conversational” user-input. Therefore, the intelligent generation of a calendar event by an example system may reduce the time a user might otherwise spend creating such a calendar event.

The calendar event may be generated using the language provided in the spoken-language description of the speech segment. This may be done by intelligently parsing out words and phrases from the description that are associated with the substance of the event, location of the event, event attendees, and/or the time of the event. For example, a user may say “meeting with Ben and Jordan on Thursday at 8 PM at Starbucks”. The system may go on to parse out the relevant information and insert it into “what”, “where””, “who”, and/or “when” fields. In this case, the what-field may be determined as “meeting”, the where-field may be determined as “Starbucks”, the who-field may be determined as “Ben and Jordan”, and the when-field may be determined as “Thursday at 8 PM”.

Also, the system may automatically determine contacts from an address book associated with the user-account. The contacts may be determined based on the spoken-language description, based on a frequency of interaction with the contacts, and/or based on the location information, among other possibilities. Further, the user may set event-reminders, edit the event, and see a schedule of upcoming or previous calendar events.

Further, in an example embodiment, the calendar event may include structured data such as location information. In particular, the system may receive an indication of location information. The location information may include the user's current location, location of event attendees, and/or business information such as the address at which an event is taking place, among others. The system may then use at least one piece of location information (e.g., user's current location) to determine at least one other piece of location information (e.g., location of the event).

For example, the system may receive an indication that the user's current location is Chicago, Ill. and may also receive an indication that an event is happening at “the Zoo”. In this case, the system may determine the location of the event to be at the nearest Chicago zoo (considering the city of Chicago, Ill. may have multiple zoos).

In another case, the system may use a user's expected location near the time of the event to determine the location of an event. For example, the system may receive a speech segment from a user saying “meeting with John to study at the coffee shop this Friday at 1 PM.” Further, the user's calendar may indicate that the user has a class at the university at noon on Friday. Therefore, the system may go on to determine that the location of the event is at a coffee shop near the university's location. Note that this determination is done based on user's expected location near the time of the event rather than the user's current location. Other examples may also be possible.

### II. EXAMPLE WEARABLE COMPUTING DEVICES

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device (HMD).

An example system may also be implemented in or take the form of other devices, such as a mobile phone, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

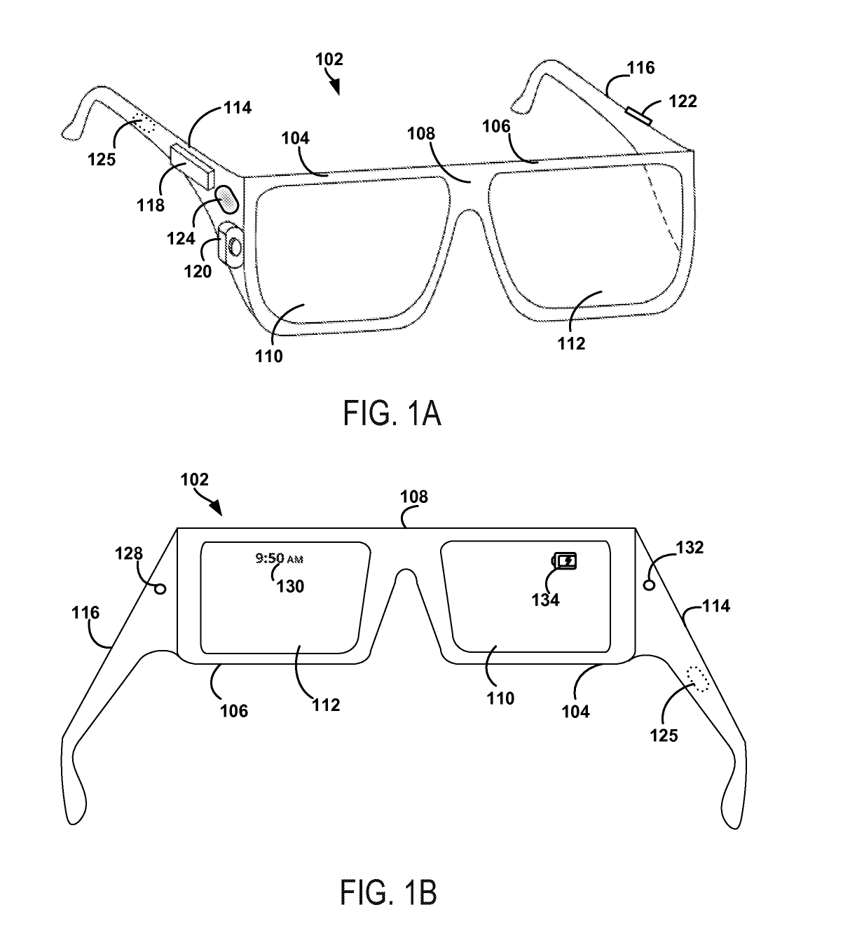

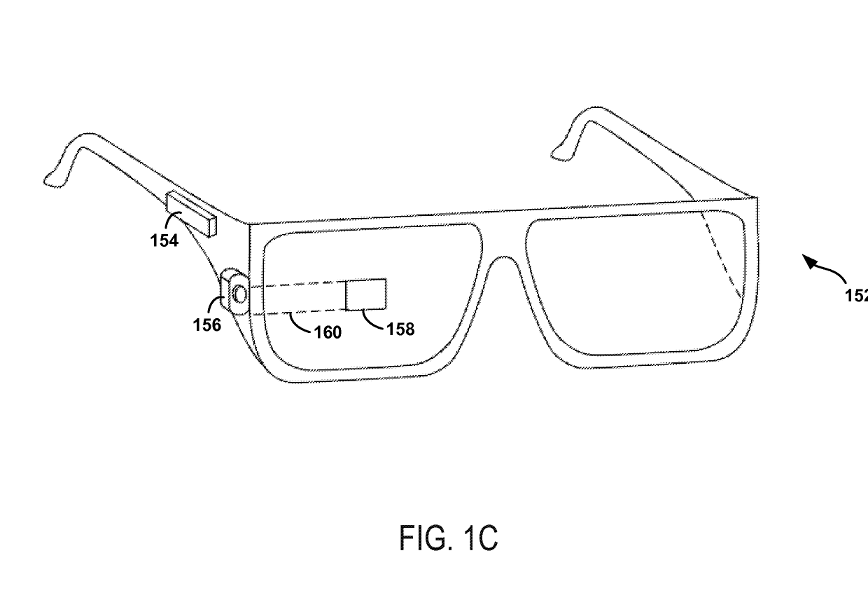

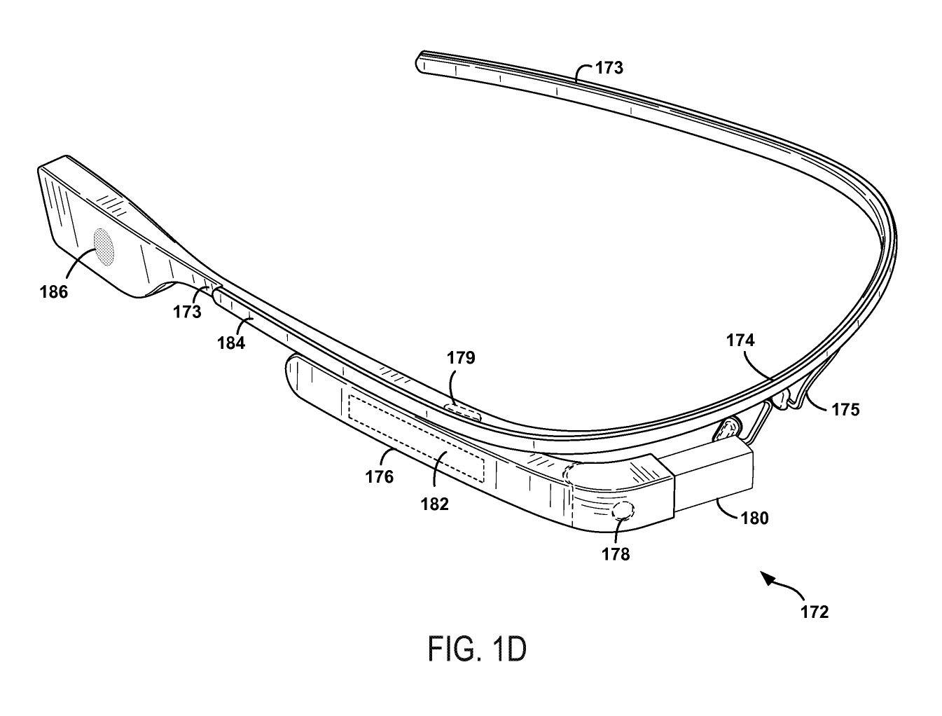

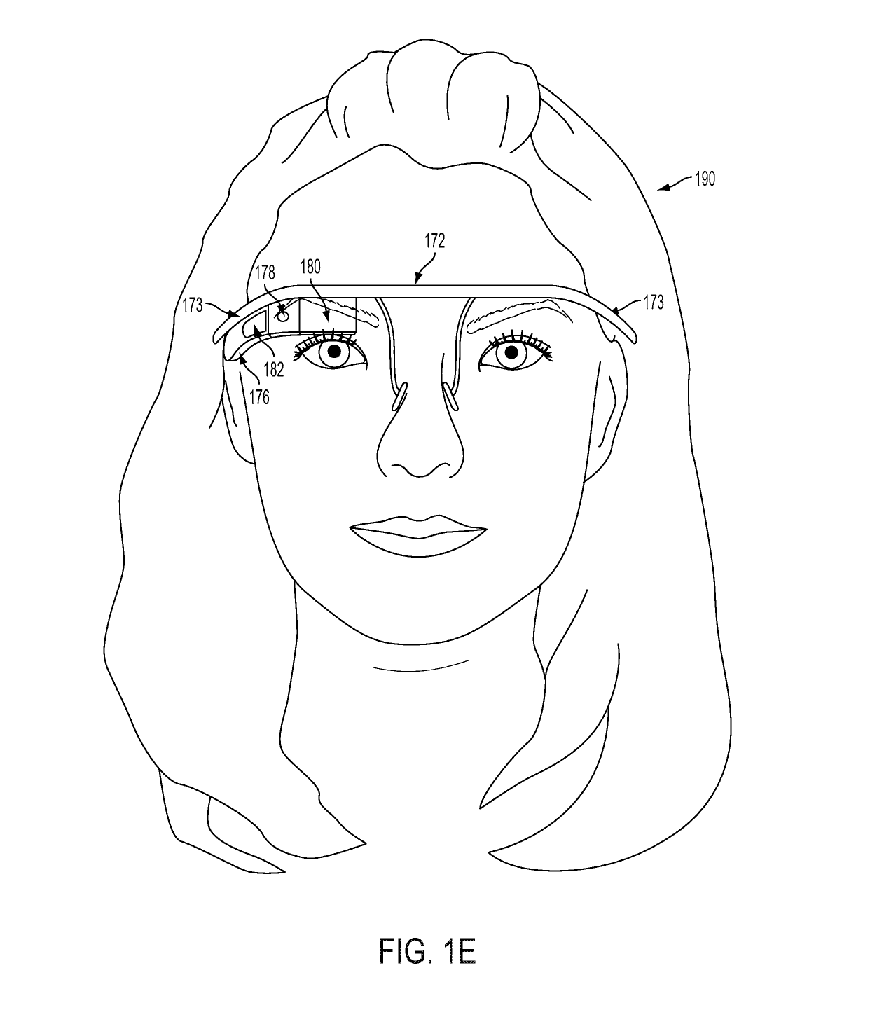

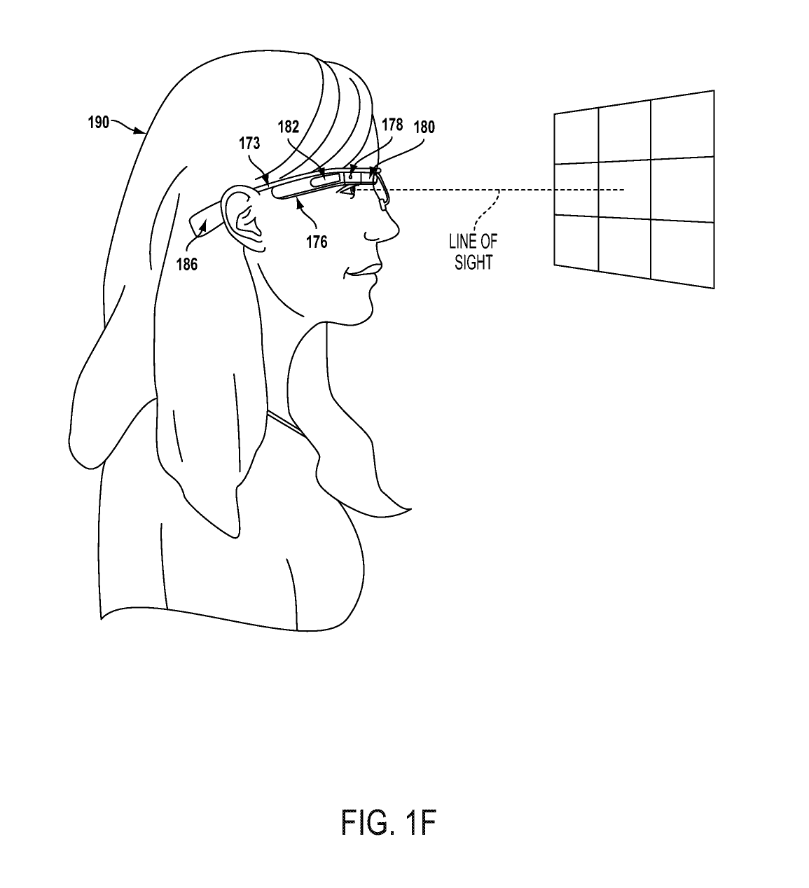

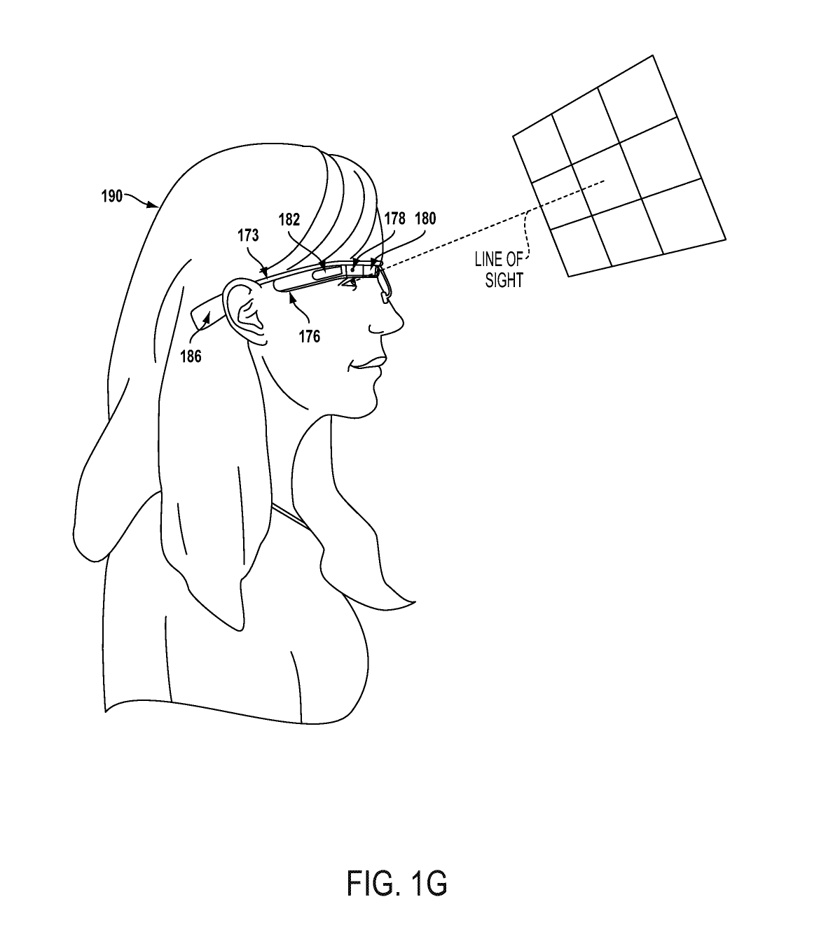

FIG. 1A illustrates a wearable computing system according to an example embodiment. In FIG. 1A, the wearable computing system takes the form of a head-mountable device (HMD) 102 (which may also be referred to as a head-mounted display). It should be understood, however, that example systems and devices may take the form of or be implemented within or in association with other types of devices, without departing from the scope of the invention. As illustrated in FIG. 1A, the HMD 102 includes frame elements including lens-frames 104, 106 and a center frame support 108, lens elements 110, 112, and extending side-arms 114, 116. The center frame support 108 and the extending side-arms 114, 116 are configured to secure the HMD 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the HMD 102 to the user. The extending side-arms 114, 116 may further secure the HMD 102 to the user by extending around a rear portion of the user's head. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touch pad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touch pad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. The image capture device 120 may be configured to capture images at various resolutions or at different frame rates. Many image capture devices with a small form-factor, such as the cameras used in mobile phones or webcams, for example, may be incorporated into an example of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user.

The sensor 122 is shown on the extending side-arm 116 of the HMD 102; however, the sensor 122 may be positioned on other parts of the HMD 102. For illustrative purposes, only one sensor 122 is shown. However, in an example embodiment, the HMD 102 may include multiple sensors. For example, an HMD 102 may include sensors 102 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 124 is shown on the extending side-arm 114 of the HMD 102. However, the finger-operable touch pad 124 may be positioned on other parts of the HMD 102. Also, more than one finger-operable touch pad may be present on the HMD 102. The finger-operable touch pad 124 may be used by a user to input commands. The finger-operable touch pad 124 may sense at least one of a pressure, position and/or a movement of one or more fingers via capacitive sensing, resistance sensing, or a surface acoustic wave process, among other possibilities. The finger-operable touch pad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

In a further aspect, HMD 102 may be configured to receive user input in various ways, in addition or in the alternative to user input received via finger-operable touch pad 124. For example, on-board computing system 118 may implement a speech-to-text process and utilize a syntax that maps certain spoken commands to certain actions. In addition, HMD 102 may include one or more microphones via which a wearer's speech may be captured. Configured as such, HMD 102 may be operable to detect spoken commands and carry out various computing functions that correspond to the spoken commands.

As another example, HMD 102 may interpret certain head-movements as user input. For example, when HMD 102 is worn, HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, HMD 102 may interpret certain gestures (e.g., by a wearer's hand or hands) as user input. For example, HMD 102 may capture hand movements by analyzing image data from image capture device 120, and initiate actions that are defined as corresponding to certain hand movements.

As a further example, HMD 102 may interpret eye movement as user input. In particular, HMD 102 may include one or more inward-facing image capture devices and/or one or more other inward-facing sensors (not shown) sense a user's eye movements and/or positioning. As such, certain eye movements may be mapped to certain actions. For example, certain actions may be defined as corresponding to movement of the eye in a certain direction, a blink, and/or a wink, among other possibilities.

HMD 102 also includes a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of HMD 102 may be designed such that when a user wears HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions, such as for example towards either the upper or lower portions of the wearer's field of view. The display 158 is controllable via the computing system 154 that is coupled to the display 158 via an optical waveguide 160.

FIG. 1D illustrates another wearable computing system according to an example embodiment, which takes the form of a monocular HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD. HMD 172 also includes a BCT 186.

The HMD 172 may include a single display 180, which may be coupled to one of the side-arms 173 via the component housing 176. In an example embodiment, the display 180 may be a see-through display, which is made of glass and/or another transparent or translucent material, such that the wearer can see their environment through the display 180. Further, the component housing 176 may include the light sources (not shown) for the display 180 and/or optical elements (not shown) to direct light from the light sources to the display 180. As such, display 180 may include optical features that direct light that is generated by such light sources towards the wearer's eye, when HMD 172 is being worn.

In a further aspect, HMD 172 may include a sliding feature 184, which may be used to adjust the length of the side-arms 173. Thus, sliding feature 184 may be used to adjust the fit of HMD 172. Further, an HMD may include other features that allow a wearer to adjust the fit of the HMD, without departing from the scope of the invention.

FIGS. 1E to 1G are simplified illustrations of the HMD 172 shown in FIG. 1D, being worn by a wearer 190. As shown in FIG. 1F, when HMD 172 is worn, BCT 186 is arranged such that when HMD 172 is worn, BCT 186 is located behind the wearer's ear. As such, BCT 186 is not visible from the perspective shown in FIG. 1E.

In the illustrated example, the display 180 may be arranged such that when HMD 172 is worn, display 180 is positioned in front of or proximate to a user's eye when the HMD 172 is worn by a user. For example, display 180 may be positioned below the center frame support and above the center of the wearer's eye, as shown in FIG. 1E. Further, in the illustrated configuration, display 180 may be offset from the center of the wearer's eye (e.g., so that the center of display 180 is positioned to the right and above of the center of the wearer's eye, from the wearer's perspective).

Configured as shown in FIGS. 1E to 1G, display 180 may be located in the periphery of the field of view of the wearer 190, when HMD 172 is worn. Thus, as shown by FIG. 1F, when the wearer 190 looks forward, the wearer 190 may see the display 180 with their peripheral vision. As a result, display 180 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 180 is located as shown, the wearer 190 may view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

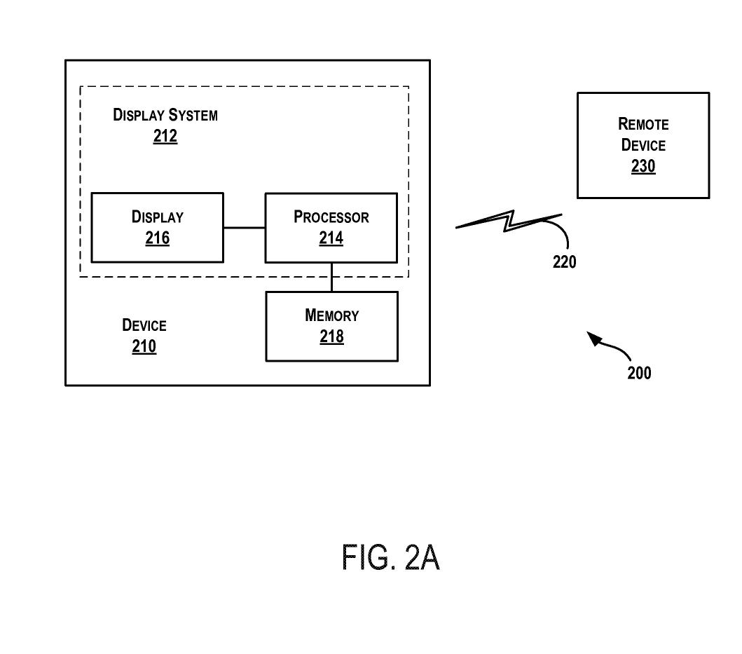

FIG. 2A is a simplified block diagram a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may take the form of or include a head-mountable display, such as the head-mounted devices 102, 152, or 172 that are described with reference to FIGS. 1A to 1G.

The device 210 may include a processor 214 and a display 216. The display 216 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, head-mountable display, tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 2A, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

### III. ILLUSTRATIVE METHODS

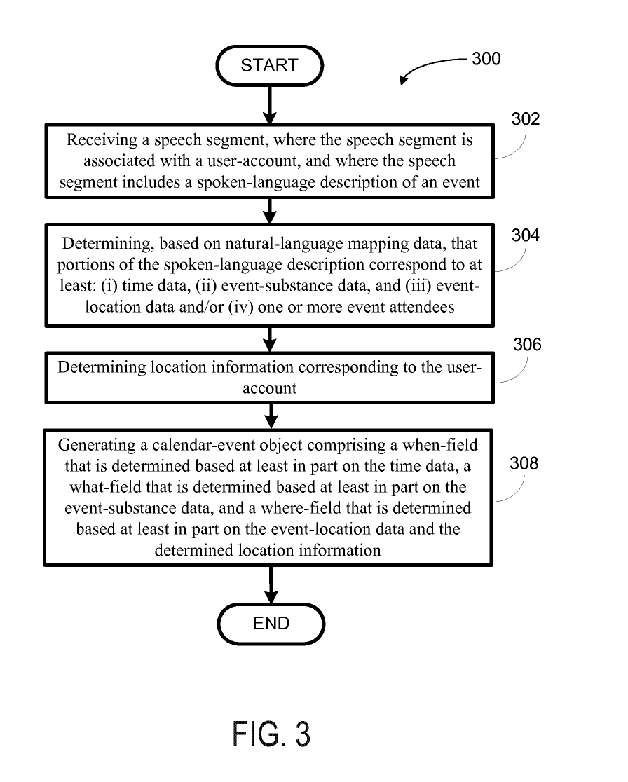

FIG. 3 is a flowchart illustrating a method 300, according to an example embodiment. In particular, method 300 may be implemented to automatically generate a calendar event with structured data from free-form speech. Method 300 may be implemented in a remote server (e.g., cloud server) and/or a device such as HMDs 102, 152, and 172 described above in association with FIGS. 1A-1D (or more particularly by one or more components or subsystems thereof, such as by a processor and a non-transitory computer-readable medium having instructions that are executable to cause the device to perform functions described herein). Additionally or alternatively, method 300 may be implemented in any other computing system such as a computer, a smartphone, and/or a tablet, among other possibilities.

In particular, method 300 involves a computing system (such as a remote server) receiving a speech segment, where the speech segment is associated with a user-account, and where the speech segment includes a spoken-language description of an event, as shown by block 302. Based on natural-language mapping data, the computing system determines that portions of the spoken-language description correspond to at least: (i) time data, (ii) event-substance data, (iii) event-location data, and/or (iv) one or more event attendees, as shown by block 304. Further, the computing system may determine location information corresponding to the user-account, as shown by block 306. (Location information corresponding to the user-account may indicate, for example, a user's current location, or a user's planned location at a future time, such as near to the time of a future event.) The computing system may then generate a calendar-event object, which includes a when-field that is determined based at least in part on the time data, a what-field that is determined based at least in part on the event-substance data, and a where-field that is determined based at least in part on both the event-location data and the determined location information, as shown by block 308. Note that in some cases, the calendar-event may also include a when-field that is set based on the one or more event attendees.

A. Receiving Data for Calendar Event Generation

As noted above, block 302 of method 300 involves receiving a speech segment, where the speech segment is associated with a user-account, and where the speech segment includes a spoken-language description of an event. The speech segment may include an audio segment, a transcription of the speech (i.e., text), or both. Further, the speech segment may come in the form of a question, a request for an action, or a command, among other possibilities.

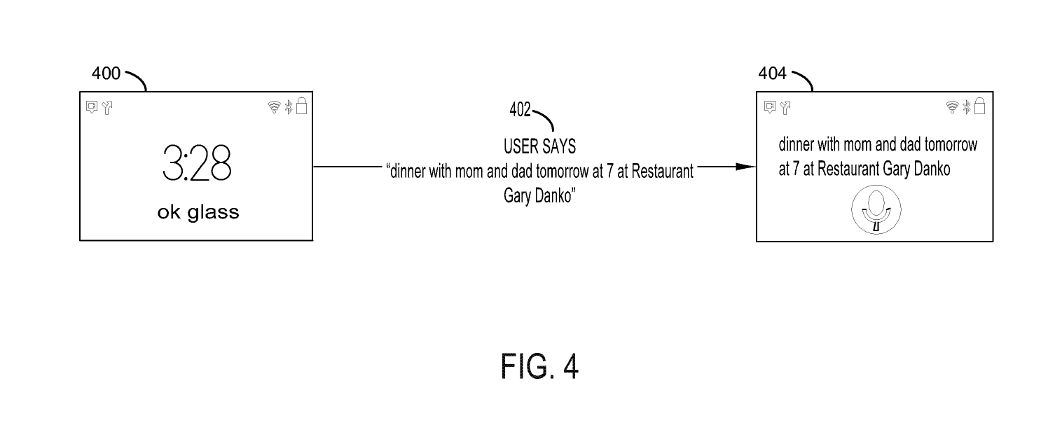

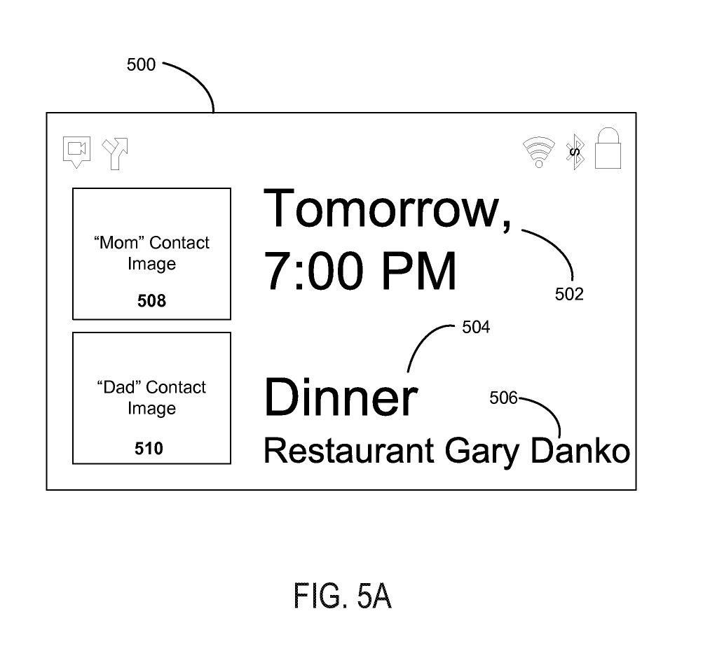

To illustrate, consider FIG. 4 showing the process of receiving a speech segment from a user of an HMD. An HMD may operate in a home-screen mode, where certain speech commands can be enabled by saying the guard phrase “ok glass.” This may be implemented by loading a hotword process that listens only for the phrase “ok glass.” While in the home-screen mode, the HMD may display “ok glass” as a visual cue that the guard phrase can be used to enable speech interaction, as shown by screen view 400.

In one case, the process of automatically generating the calendar event may be initiated by receiving a speech command such as “add a calendar event” (not shown) followed by an example speech segment 402 that includes a spoken-language description of the event (e.g., “dinner with mom and dad tomorrow at 7 at Restaurant Gary Danko”). The spoken-language description of the desired calendar event may be fairly crude, and may thus be referred to as “conversational” user-input or a natural-language description. Note that the speech command “add a calendar event” may not be necessary to initiate the process of automatically generating the calendar event (i.e., the HMD may simply receive a speech segment). Also, note that the process may be initiated at any screen view (i.e., a screen view other than screen view 400).

As mentioned above, a speech segment may be associated with a user-account. In particular, the desired event generation may be inferred from the speech segment and/or context information related to a user-account associated with the speech segment. In other words, the HMD may include a feature or features that provide the system with context information that a user has elected to make available via a user-account.

For example, a user may provide consent to use of certain information by the system, such as location information, calendar information, contact information, information related to past interactions with contacts, and/or past use of certain applications, among other possibilities. The context information related to the user-account may assist the system in generating a personalized, intelligently-composed calendar event.

As shown in FIG. 4, the received example speech segment 402 may be displayed via screen view 404. The example speech segment 402 may be displayed in order for a user of the HMD to verify that the system has correctly interpreted the user's speech input. At this point, a user may wish to edit the example speech segment 402 or go on with the process of generating a calendar event.

Once the system has determined that the speech segment comprises a spoken-language description of a desired calendar event, the calendar event may be generated based on the spoken-language description and/or context information related to a user-account associated with the speech segment. This process may allow for intelligently creating a calendar event, as well as reducing the time a user might otherwise spend creating such a calendar event without such automated intelligence.

B. Determining Calendar-Event Fields from a Speech Segment

At block 304, method 300 involves determining, based on natural-language mapping data, that portions of the spoken-language description correspond to at least: (i) time data (e.g., for a “when” field of a structured calendar event), (ii) event-substance data (e.g., for a “what” field of a structured calendar event), (iii) event-location data (e.g., for a “when” field of a structured calendar event), and/or (iv) one or more event attendees (e.g., for a “who” field of a structured calendar event). The natural-language mapping data may be stored in memory storage and may be processed by a natural-language processing (NLP) engine. The mapping may include a search for relevant keywords and phrases that correspond to the portions of the spoken-language description discussed herein.

In some embodiments, the time data derived from the spoken-language description may include a time of the event, a date of the event and/or a day of the week for the event. In one case, portions of the spoken-language description that correspond to time data may include words that follow keywords such as “at”, “from”, “to”, “in” or “on”. For example, the system may receive a speech segment from a user of the HMD saying “at 1 PM”, “in 5 weeks”, “on Thursday”, “at 1 PM on Thursday”, “workout from 5 PM to 7 PM” etc. In another case, the system may recognize special time phrases/terms including but not limited to: “morning”, “evening”, “afternoon”, “noon”, “midnight”, “sunrise”, “sunset”, “dinner”, “breakfast”, “lunch”, “tomorrow”, “in one week” and so on.

Note that the system may be configured to recognize special time-related terms, such as “sunset” or “dinner”, and automatically determine respective times of day that corresponds to such terms. In one example, if the system recognizes the term “sunset” in a speech segment, the system may determine the actual time of the sunset on the day of an event. In another example, if the system recognizes the term “dinner”, the system may determine a particular time of day (if no particular time of day is provided) for the calendar event based on information in the user-account such as the time of a previous relevant event involving dinner and/or based on other information associated with the user-account, or may default to a predetermined dinner time (e.g., 6:00 pm). Note that in some cases the system may recognize multiple special time-related terms. In such case, the system may use a ranking system to determine which terms or phrases are most relevant, and/or may use relationships between the time-related terms to make a more-refined determination as to the time-of-day for the event.

As mentioned above, the system may determine that portions of the spoken-language description indicate or otherwise relate to the location of the event (i.e., event-location data). Examples of such location-related language may include words or phrases that follow certain keywords, such as “at”, “on”, “to” or “in” (e.g., “in Chicago” or “at the Tokyo Sushi” or “located on 123 Main Street” or “going to the beach”). In some cases, the system may determine that portions of the spoke-language description include special location phrases/terms such as “street”, “road”, “court”, and/or any other word associated with an address or a location. Other examples may also be possible

Note that when a determination is made that the spoken-language description includes the keyword “at”, the system may first determine that the word that follows is not an indication of time but rather an indication of a location. Similarly, when a determination is made that the spoken-language description includes the keyword “on”, the system may first determine that the word that follows is not an indication of time but rather an indication of a location (e.g., “meeting on State Street” versus “meeting on Tuesday”). This concept may similarly be applied to the keywords “to” and “in”, among others.

In some embodiments, as mentioned above, the system may determine that portions of the spoken-language description correspond to event attendees. Portions of the spoken-language description that correspond to event attendees may include words that follow keywords such as “with” or “to” (e.g., “with mom and dad” or “send an invitation to Ben for my birthday”). Note that when a determination is made that the spoken-language description includes the keyword “to”, the system may first determine that the word that follows is not an indication of location or time but rather an indication of event attendees (e.g., “send an invitation to Ben” versus “going to the beach” or “workout from 5 PM to 7 PM”).

In some cases, the system may determine that a portion of the spoken-language description corresponding to an event attendee is a name of a contact associate with the user-account. Determination of contacts will be further discussed below.

In some embodiments, as mentioned above, the system may determine that portions of the spoken-language description correspond to a substance of the event (i.e., event-substance data). The portions of the spoken-language description that correspond to the substance of the event may be determined as the remaining portion of the spoken-language description. Alternatively, the system may determine that a portion of the spoken-language description corresponds to a keyword or a phrase from a database of words associated with a substance of an event (e.g., “tennis” or “meeting” or “birthday”).

To illustrate, consider again FIG. 4 showing example speech segment 402 (i.e., “dinner with mom and dad tomorrow at 7 at Restaurant Gary Danko”). Based on the discussion above, the system may determine that the portion of the spoken-language description corresponding to time data is “7” based on the keyword “at”. Additionally, the system may determine that the portion of the spoken-language description corresponding to the location of the event is “Restaurant Gary Danko” based on the keyword “at” and a determination that the word that follows “at” is not an indication of time but rather an indication of a location. Further, the system may determine that the portions of the spoken-language description corresponding to the event attendees are “mom” and “dad”. This determination may be done based on the keyword the keyword “with” and/or based on the names of a contacts associate with the user-account (i.e., contacts mom and dad), among other possibilities.

Once determinations have been made for the time data, location of the event, and the event attendees; the system may determine the substance of the event based the remaining portion (i.e., “dinner”) and/or based the determination that a portion of the spoken-language description corresponds to a keyword or a phrase from a database of words associated with a substance of an event. Note that the sequence of determination described herein may occur at any logical order (e.g., the location of the event may be determined prior to time data etc.).

C. Using Provided Location Information to Help Determine a Location of an Event

At block 306, method 300 involves determining location information corresponding to the user-account. The location information may include business information, an address, directions, current-location information, and/or location of event attendees, among others. The business information may include information such as business hours, restaurant menus, and reviews, among other possibilities. Further, the location information may also include latitude/longitude information and/or a map. The map may further include the directions to an event, the current-location information, the location of event attendees, the address, and/or the business information described above. Other examples may also be possible.

In some cases, the location information may be provided by the device (e.g., an HMD) that receives the request to generate a calendar event. Alternatively, the location information may be obtained from the user-account currently associated with the device and/or the received speech segment described above.

In some embodiments, determining location information may include determining the location of the event. In one case, this determination may be done based on current-location information. The current-location information may correspond to the system's (i.e., the device or HMD etc.) current location which may also represent the user's current location. Additionally, determining the current-location information may be based on satellite, GPS, and/or nearby Wi-Fi information, among other possibilities.

For example, if a user of the HMD is located in Chicago, Ill. and has made an indication that an event is happening at “Bubba Gump Shrimp Restaurant” then the system may determine the location of the event is at the “Bubba Gump Shrimp Restaurant” located in Chicago, Ill. rather than other “Bubba Gump Shrimp Restaurant” locations. In another example, if a user of the HMD is located in Chicago, Ill. and has made an indication that an event is happening at “the Zoo” the system may determine the location of the event to be at the nearest zoo (considering the city of Chicago, Ill. may have multiple zoos).

In another case, determining location information may include determining the location of the event based on a location of event attendees. Assuming consent has been provided by the event attendees, the system (or the event requestor's user-account) may have access to the user-accounts associated with the event attendees. Therefore, the system may obtain location information including the location of the event attendees. The location of the event attendees may then be used to determine the location of an event. For example, an HMD may receive a speech segment from a user saying “meet with friends tomorrow in the nearest park to Ben's house.”

In some embodiments, determining location information may assist the system with determination of time data associated with the calendar event. In one example, if an HMD receives a speech segment from a user saying “meeting at 9 at Starbucks”, the system may go on to use location information such as the nearest Starbucks' business hours to determine an appropriate time for the event. In other words, if the nearest Starbucks is open from 12 PM to 10 PM, the system may determine that the time of the event is 9 PM based on the determined business hours. Further, the system may also use the nearest Starbucks' location to determine the time zone in which the event is happening. Other examples may also be possible.

### VI. GENERATING A CALENDAR-EVENT OBJECT

At block 308, method 300 involves generating a calendar-event object comprising a when-field that is determined based at least in part on the time data, a what-field that is determined based at least in part on the event-substance data, and a where-field that is determined based at least in part on the event-location data and the determined location information. Note that, additionally or alternatively, the calendar-event may include a when-field that is set based on the event attendees.

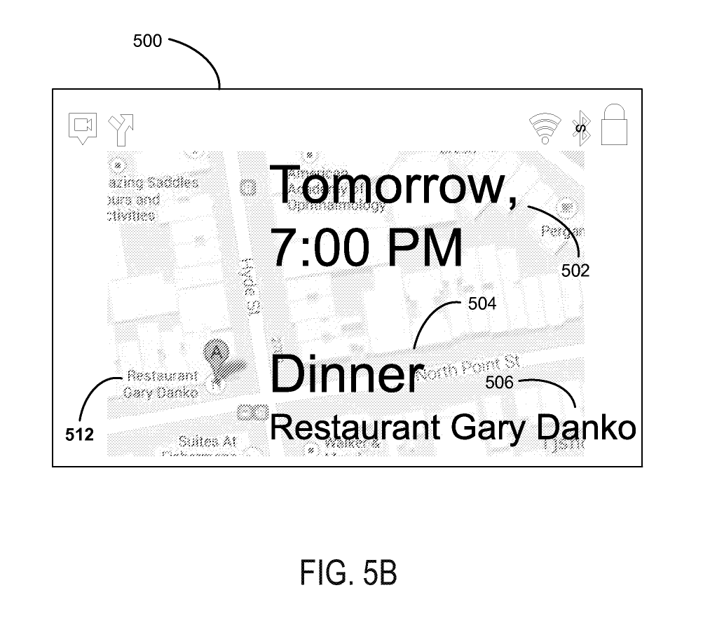

Logic may be implemented to extract or infer information from the portions of the spoken language description (i.e., time data, location of the event, substance of the event, and/or event attendees), and to insert such information into “when”, “where”, “who”, and/or “what” fields of a calendar event. To illustrate, consider the calendar-event object shown in screen view 500 of FIG. 5A. Screen view 500 shows the portions of example speech segment 402 associated with FIG. 4 as the portions have been parsed out and inserted into the fields described herein.

As shown, example when-field 502 may describe the time data associated with the event (i.e., Tomorrow, 7:00 PM). Additionally, example what-field 504 may describe the substance of the event (i.e., Dinner). Further, example where-field 506 may describe the location of the event (i.e., Restaurant Gary Danko). Yet further, as mentioned above, the calendar-event object may include an example who-field which may describe the event attendees (i.e., mom and dad). In some cases, the calendar-event object may show the who-field in the form of contact images such as “Mom” contact image 508 and “Dad” contact image 510. Note that if not enough information has been provided by the user to determine the fields described herein, the system may prompt the user to provide additional information.

In some cases, the where-field of the calendar-event object is also set based on the determined location information discussed above. For example, FIG. 5B shows screen view 500 of FIG. 5A with location information included in the form of structured data. In particular, FIG. 5B shows example map 512 which may be used to assist the user of an HMD with directions to the event, among other possibilities.

Many other types of information, from many different sources, may be used to generate the calendar-event object. For example, the information may include: (a) the current time, (b) the current date, (c) the current day of the week, (d) the current month, (e) the current season, (f) a time of a future event or future user-context, (g) a date of a future event or future user-context, (h) a day of the week of a future event or future context, (i) a month of a future event or future user-context, (j) a season of a future event or future user-context, (k) a time of a past event or past user-context, (l) a date of a past event or past user-context, (m) a day of the week of a past event or past user-context, (n) a month of a past event or past user-context, (o) a season of a past event or past user-context, ambient temperature near the user (or near a monitoring device associated with a user), (p) a current, future, and/or past weather forecast at or near a user's current location, (q) a current, future, and/or past weather forecast at or near a location of a planned event in which a user and/or a user's friends plan to participate, (r) a current, future, and/or past weather forecast at or near a location of a previous event in which a user and/or a user's friends participated, (s) information on user's calendar, such as information regarding events or statuses of a user or a user's friends, (t) information accessible via a user's social networking account, such as information relating a user's status, statuses of a user's friends in a social network group, and/or communications between the user and the users friends, (u) noise level or any recognizable sounds detected by a monitoring device, (v) items that are currently detected by a monitoring device, (w) items that have been detected in the past by the monitoring device, (x) items that other devices associated with a monitoring device (e.g., a “trusted” monitoring device) are currently monitoring or have monitored in the past, (y) information derived from cross-referencing any two or more of: information on a user's calendar, information available via a user's social networking account, and/or other context signals or sources of context information, (z) health statistics or characterizations of a user's current health (e.g., whether a user has a fever or whether a user just woke up from being asleep), and (aa) a user's recent context as determined from sensors on or near the user and/or other sources of context information, (bb) a current location, (cc) a past location, and (dd) a future location.

Those skilled in the art will understand that the above list of possible context-based information and sources of context-based information is not intended to be limiting, and that other information and/or sources of information are possible in addition, or in the alternative, to those listed above. Also, note that machine learning techniques could be used to improve the calendar event generation process over time.

In some embodiments, as mentioned above, a when-field of the calendar-event object may be set based on the time data. In some cases, the time at which a request to create a calendar event is made, may help the system determine the correct time of the calendar event. For example, if a user makes a request at 2 PM and indicates that an event is taking place “at 7” then the system may determine that the event is at 7 PM that day. In another example, if a user makes a request at 10 PM and indicates that an event is taking place “at 7” then the system may determine that the event is at 7 AM the next day. In yet another example, a user may indicate that an event is taking place “on Thursday”, thus the system may determine that the event is taking place on the upcoming Thursday.

In some cases, the user may indicate a date but not a time. In this case, the system may determine that an event is an all-day event (e.g. Dan's birthday). Further, as mentioned above, the system may use keywords to determine the appropriate time for the event. For example, if the system receives a speech segment from the user saying “dinner at 7”, the system may determine that the user means 7 PM based on the keyword “dinner”. Other examples may also be possible.

In some embodiments, as mentioned above, a where-field of the calendar-event object may be set based on the location of the event and/or the determined location information. As discussed above, the calendar-event object may include the portions of the spoken-language description corresponding to location of the event. Further, the calendar-event object may also include the location information determined as discussed above in section V.

In some embodiments, as mentioned above, a who-field of the calendar-event object may be set based on the event attendees. In particular, generating a calendar-event object may also include determining address book contacts corresponding to event attendees. In some cases, the contacts may be uniquely identified based on only the info extracted or inferred from the speech segment. However, in other cases, there may be multiple contacts that are candidates to be included in the calendar-event object. Therefore, context, historical interaction, and account preferences etc. may be used to disambiguate.

In one example, the contacts may be determined based on the spoken-language description of the event. For instance, consider a situation where the user indicates John as an attendee when the user's address book contacts associated with the user-account include “John Dad” and “John Boss”. If the contents of the spoken-language description include an indication of a business related event, the system may determine “John Boss” as the appropriate contact.

In another example, the contacts may be determined based on a frequency of interaction with a plurality of contacts. In particular, the system may use a ranking system to determine the contact(s) to include in the calendar-event object. For instance, consider again the situation where the user indicates John as an attendee when the user's address book contacts associated with the user-account include “John Dad” and “John Boss”. In this case, the system may determine that the user intended to include “John Dad” based on the fact that the user interacts more frequently with “John Dad” than with “John Boss”.

In yet another example, the contacts may be determined based the location information, where the location information includes a location of the event attendees. For instance, the system may disambiguate contacts based on their proximity to the requestor's location. To illustrate, consider a situation where an HMD receives a speech segment from a user saying “meeting with John at 1 PM in Starbucks”. The address book contacts associated with the user-account may include more than one John. In this case, the system may obtain (given user consent) the address or current location of all “Johns” in the address book and go on to determine the appropriate John based on proximity to the user's current-location information and/or the location of the event.

Additionally, once the system has determined the appropriate contacts it may subsequently include contact information as part of the calendar-event object. In some cases, the system may use the contact information to send an event invitation to the desired event attendees. This may be done automatically or the system may prompt the user to send the invitation. Note that using the contact information, the system may provide assistance with contacting the attendees regarding the event. Also note that the system may prompt the user to add unrecognized contact(s) to the contact list. Furthermore, the system may gather contact and/or user information over time in order to improve the intelligent determination of contact(s).

In some embodiments, as mentioned above, a what-field of the calendar-event object may be set based on the substance of the event. Similarly to the discussion above associated with section IV, once the “when”, “where”, and “who” fields have been determined, the what-field may be determined based on the remaining words in the description. In an additional example, an HMD may receive a speech segment from a user saying “tennis with Dan on Sunday at Grove Park”. Subsequently, the system may determine the when-field to be “Sunday”, the where-field to be “Grove Park”, and the who-field to be “Dan”. Therefore, the system may determine that the remaining portion of the spoken-language description is the word “Tennis” and thus insert it into the what-field.

Alternatively, as discussed above, there may be a database of words and phrases associated with a substance of an event. In this case, the system may recognize that a portion of the spoken-language description corresponds to a word or a phrase stored in the database.

### VII. EDITING THE EVENT, EVENT SCHEDULES, AND EVENT REMINDERS

(i) Editing the Event

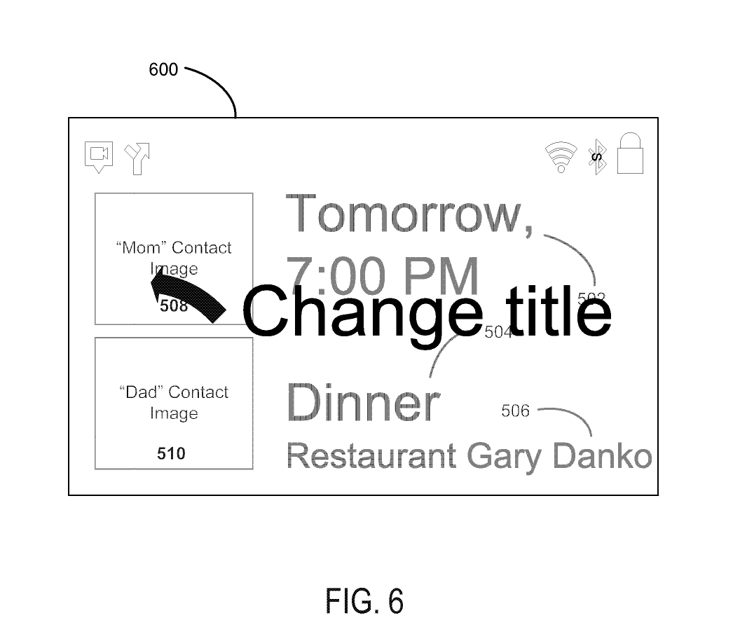

In some embodiments, the user may wish to edit the generated calendar-event object. Editing the event may be done using natural-language commands/requests such as “edit the title of the event tomorrow at Restaurant Gary Danko”. The user may edit the event at any point in time. For example, the user may edit the initial request in the midst of providing the original spoken-language description and/or while the system is generating the calendar-event object. In another example, the system may prompt the user to confirm that the generated calendar-event object is correct. If a user chooses to edit the calendar-event object, the system may then receive a user request to change a specific word, phrase, name, field etc. and/or add additional content to the calendar-event object. Note that, as shown in FIG. 6, a screen view 600 may be displayed showing the field being edited (i.e., Change title).

(ii) Event Schedules

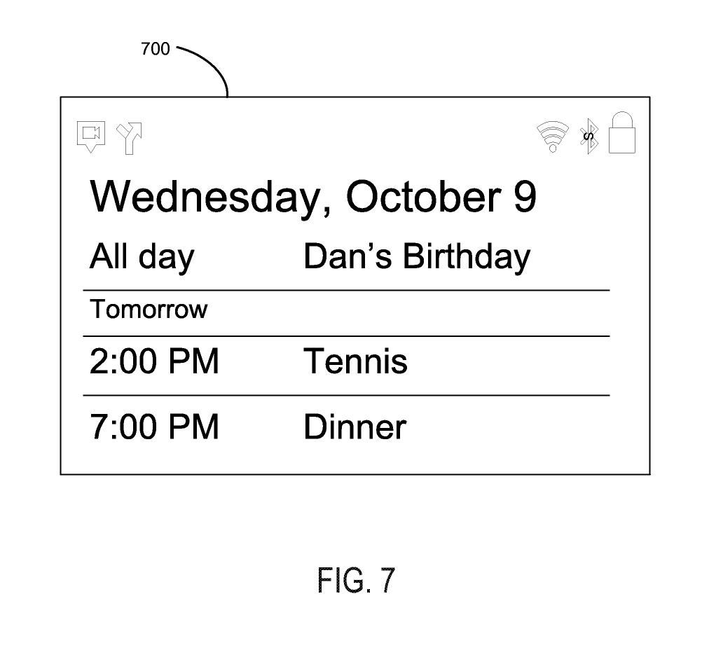

In some embodiments, the user may request to see a schedule of previous, current, and/or future events. To illustrate, consider FIG. 7 including example screen view 700 showing an example schedule of upcoming events. Note that the system may also create a new calendar-event object based on a previous calendar event featured in an event schedule. For example, the system may receive a speech segment from the user saying “create an event for tennis tomorrow like the tennis event from last week”. Other examples may also be possible.

(iii) Event Reminder

In some embodiments, the system may send an event-reminder to a user of a computing device, where the event-reminder includes the calendar-event object. The user of a computing device may be the requestor of the event and/or the event attendees. Additionally, the event-reminder may be set to any time before the start of the event.

### VII. CONCLUSION

In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may haw control over how information is collected about the user and used by a content server.

We claim:

1. A method comprising:
receiving a speech segment, wherein the speech segment is associated with a user-account, and wherein the speech segment includes a spoken-language description of an event;
determining, based on natural-language mapping data, that portions of the spoken-language description correspond to at least: (i) time data, (ii) event-substance data, and (iii) event-location data;
determining location information corresponding to the user-account; and
generating a calendar-event object comprising a when-field that is determined based at least in part on the time data, a what-field that is determined based at least in part on the event-substance data, and a where-field that is determined based at least in part on the event-location data and the determined location information.

2. The method of claim 1, wherein portions of the spoken-language description further correspond to event attendees.

3. The method of claim 1, wherein determining location information comprises determining the event-location data based on current-location information.

4. The method of claim 1, wherein the location information comprises one or more of: (a) business information, (b) address, (c) directions, (d) current-location information, and (e) location of event attendees.

5. The method of claim 1, wherein generating a calendar-event object further comprises determining address book contacts corresponding to event attendees.

6. The method of claim 5, wherein the contacts are determined based on the spoken-language description of the event.

7. The method of claim 5, wherein the contacts are determined based on a frequency of interaction with a plurality of contacts.

8. The method of claim 5, wherein the contacts are determined based on the location information, wherein the location information comprises a location of the event attendees.

9. The method of claim 1, wherein the time data comprises one or more of: (i) time of the event, (ii) date of the event, (iii) day of the week for the event.

10. The method of claim 1, further comprising:
sending an event-reminder to a user of a computing device, wherein the event-reminder comprises the calendar-event object.

11. A system comprising:
a computing device configured to:
receive a speech segment, wherein the speech segment is associated with a user-account, and wherein the speech segment includes a spoken-language description of an event;
determine, based on natural-language mapping data, that portions of the spoken-language description correspond to at least: (i) time data, (ii) event-substance data, and (iii) event-location data;
determine location information corresponding to the user-account; and
generate a calendar-event object comprising a when-field that is determined based at least in part on the time data, a what-field that is determined based at least in part on the event-substance data, and a where-field that is determined based at least in part on the event-location data and the determined location information.

12. The system of claim 11, wherein portions of the spoken-language description further correspond to event attendees.

13. The system of claim 11, wherein the computing device configured to determine location information comprises the computing device determining the event-location data based on current-location information.

14. The system of claim 11, wherein the location information comprises one or more of: (a) business information, (b) address, (c) directions, (d) current-location information, and (e) location of event attendees.

15. The system of claim 11, wherein the computing device configured to generate a calendar-event object further comprises the computing device determining address book contacts corresponding to event attendees.

16. The system of claim 15, wherein the contacts are determined based on the spoken-language description of the event.

17. The system of claim 15, wherein the contacts are determined based on a frequency of interaction with a plurality of contacts.

18. The system of claim 15, wherein the contacts are determined based on the location information, wherein the location information comprises a location of the event attendees.

19. The system of claim 11, wherein the time data comprises one or more of: (i) time of the event, (ii) date of the event, (iii) day of the week for the event.

20. A non-transitory computer readable medium having stored therein instructions executable by a computing device to cause the computing device to perform functions comprising:
receiving a speech segment, wherein the speech segment is associated with a user-account, and wherein the speech segment includes a spoken-language description of an event;
determining, based on natural-language mapping data, that portions of the spoken-language description correspond to at least: (i) time data, (ii) event-substance data, and (iii) event-location data;
determining location information corresponding to the user-account; and
generating a calendar-event object comprising a when-field that is determined based at least in part on the time data, a what-field that is determined based at least in part on the event-substance data, and a where-field that is determined based at least in part on the event-location data and the determined location information.
